(19) United States
(12) Patent Application Publication
(10) Pub. No.: US 2018/0040036 A1
(43) Pub. Date: Feb. 8, 2018

(54) Offline Cards

(71) Applicant: Samsung Electronics Co., Ltd., Suwon-si (KR)

(72) Inventors: Hadar DOR, San Francisco, CA (US); Shravan SOGANI, San Ramon, CA (US)

(21) Appl. No.: 15/229,083

(22) Filed: Aug. 4, 2016

(51) Int. Cl. G06Q 30/02; H04W 76/02

(52) U.S. Cl. CPC G06Q 30/0277; H04W 76/028

(57) ABSTRACT

According to some implementations of the present disclosure, a method for displaying offline content using offline cards and instructions for executing the method are presented. In some implementations, the method includes receiving an offline card object including card data and content data, and storing the card data and the content data in an offline card cache. The method further includes detecting that the user device is in an offline condition. While the user device remains in the offline condition, the method includes: retrieving the card object from the offline card cache; displaying a card based on the card data via a user interface of the user device; receiving a selection of the card via the user interface of the user device; and displaying the content based on the content data via the user interface. The card includes a user selectable link to view content corresponding to the content data.

### FIELD

The present disclosure relates to displaying cards in periods of reduced network connectivity.

### BACKGROUND

Many mobile user device users are accustomed to using applications and viewing content on their respective devices all the time. A user device may, however, enter into a period of reduced network capabilities. For example, the user may be flying in an airplane or driving through an area that does not offer a Wi-Fi connection and/or a cellular network connection. During the period of reduced network capabilities, a user may wish to access content on their device. For example, a user may wish to view an article or shop for an item. Similarly, during a period of reduced network capabilities, an electronic retailer would like to have users make purchases, even though the user device is in an area having reduced network capabilities.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to some implementations of the present disclosure, a method for displaying offline content using offline cards and instructions for executing the method are presented. In some implementations, the method comprises receiving an offline card object including card data and content data, and storing the card data and the content data in an offline card cache. The method further comprises detecting that the user device is in an offline condition. While the user device remains in the offline condition, the method includes: retrieving the card object from the offline card cache; displaying a card based on the card data via a user interface of the user device; receiving a selection of the card via the user interface of the user device; and displaying the content based on the content data via the user interface. The card includes a user selectable link to view content corresponding to the content data.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1A is a schematic illustrating an example environment of a card system configured to deliver offline card objects to a user device.

FIGS. 1B-1D are schematics illustrating an example user device using an offline card object to deliver offline content using an offline card.

FIG. 2 is a schematic illustrating an example user device configured to present offline cards.

FIG. 3A is a schematic illustrating an example card system configured to deliver offline card objects.

FIG. 3B is a schematic illustrating an example offline card record.

FIG. 4 is a flowchart illustrating an example set of operations of a method for presenting offline content on a user device.

In the drawings, reference numbers may be reused to identify similar and/or identical elements.

### DETAILED DESCRIPTION

Systems and methods for providing cards when a device is in an offline condition are disclosed. As used herein, the term offline condition may refer to a situation where the user device is not connected to a computer network (e.g., the internet) or a situation where the user of the user device has indicated that the user device cannot connect to a network. For instance, if the user device can only receive data via a 3G or 4G network connection or if the user device is in a data roaming area, the user may not wish to receive content. Thus, the user may turn on a setting of the user device to disallow the receiving of non-essential content. The foregoing situation may be referred to as an offline condition because the user has explicitly decided that the user device cannot receive non-essential content. Other examples of offline conditions may include situations where the user has turned the device onto “airplane mode” (e.g., disabling wireless communication), or when the user device is located in an area where the user is unable to connect to a network.

A card system delivers card objects to a user device that is likely to enter an offline condition. A card object includes data and/or instructions that the user device uses to render a card. A card is a graphical user interface element that when selected causes the user device to access an application and set the application to a state indicated by the card. A card may display text, images, videos, input elements, and/or other suitable elements. Typically, a card object includes an access mechanism (e.g., a URL or an application resource identifier) that causes the user device to request information via a network. According to some implementations of the present disclosure, an offline card object includes data and instructions to render the card as well as the content data to which the card links. For instance, a card object may include card data that includes a title of an article, a text blurb from the article, and an image thumbnail corresponding to the article. The card object may further include content data that includes the actual article, including any images associated with the article. The content data may include hypertext markup language (HTML) code if the article is to be viewed in a web browser. In another example, the content data may include JavaScript Object Notation (JSON) data that contains the article if the article is to be viewed via a native application.

In some implementations, a card object may correspond to a state of an application that requires return data from the user. Return data may be any data that is transmitted to an application from the user device in response to a user action. The return data may be used to complete a transaction that the user initiated when the user device was in an offline condition. For example, the user may elect to purchase an item via an online retailer. Upon the user selecting the “purchase” button, the user may be prompted to enter a credit card number, a billing address, a shipping address, and the like. The user device can temporarily store this information until the user device exits the offline condition. Upon detecting that the user device has exited the offline condition, the user device can transmit the return data to the application from which the order was placed.

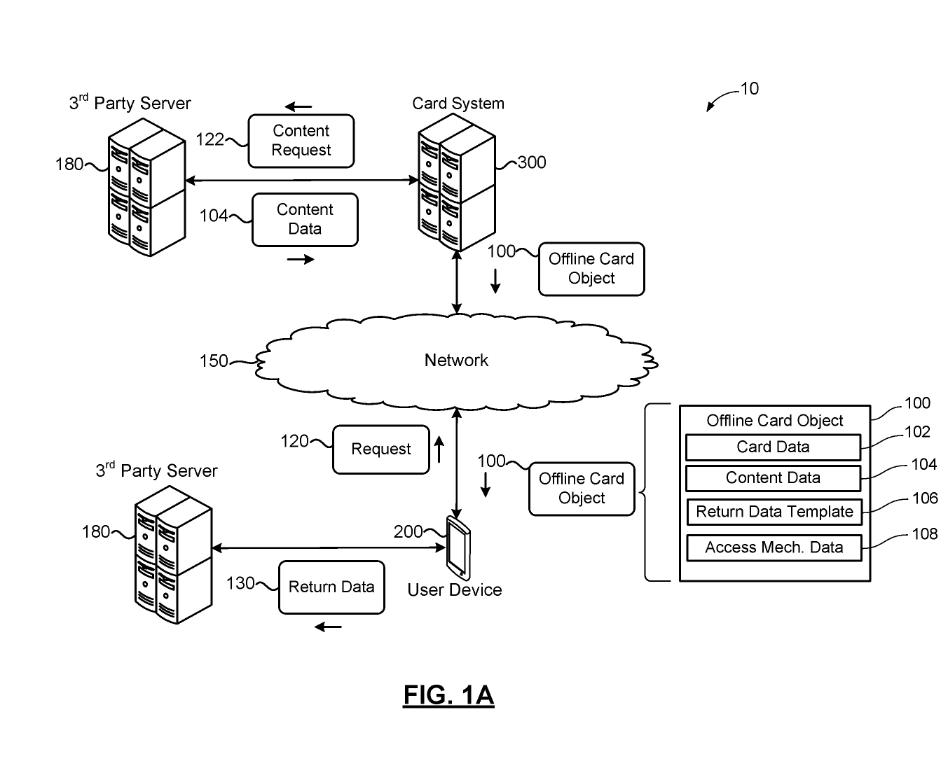

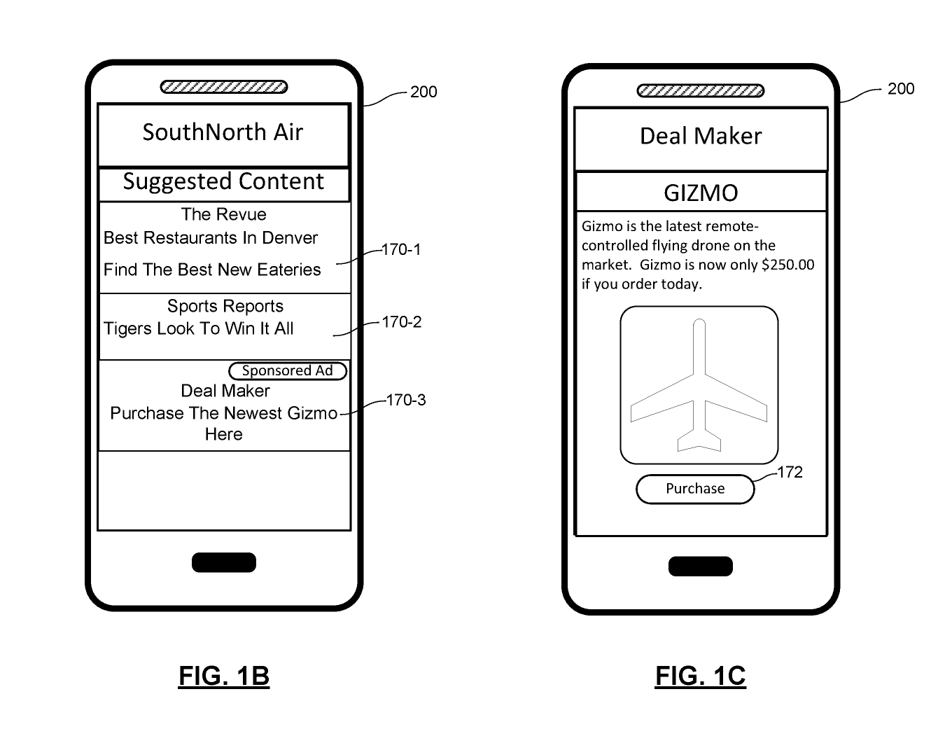

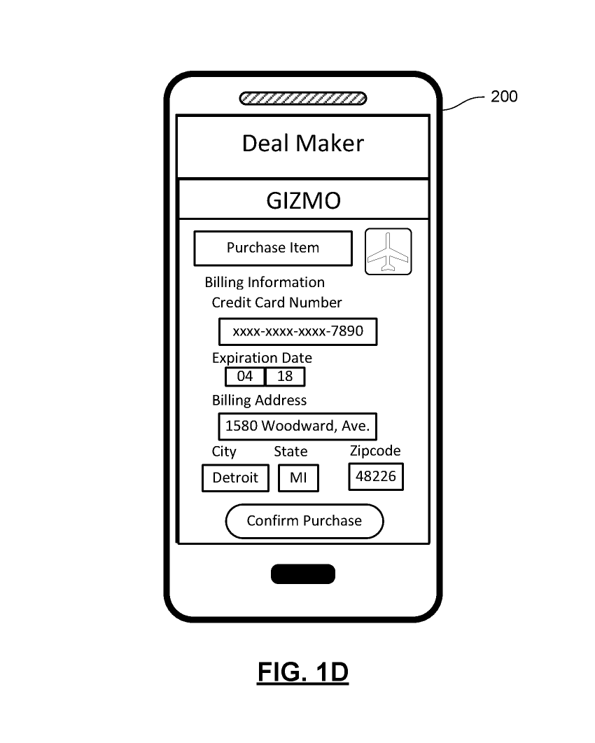

FIG. 1 illustrates an example environment of a card system 300 that is configured to deliver offline card objects 100. The card system 300 is a collection of one or more computing devices that delivers offline card objects 100 to a plurality of user devices 200. As previously discussed, an offline card object 100 is a data structure that contains data and instructions for rendering a card that links to offline content. Offline content is content that the user can access without accessing a network 150. According to some implementations, an offline card object contains card data 102 and content data 104. The card data 102 includes data and/or instructions for rendering a card. Content data 104 includes data and/or instructions for rendering the offline content. For example, content data 104 may include HTML code for rendering a particular page of a website or JSON data that defines what is presented at a particular state of a native application. The card system 300 may obtain the content data from the third party server 180 that typically serves the content. Additionally or alternatively, the content data 104 may be generated or sourced by the operator of the card system 300.

The card system 300 may deliver one or more offline card objects 100 upon determining that the user is likely to enter a period of reduced network capabilities or in response to a request 120 from the user device 200 for an offline card object 100. In the former scenario, the card system 300 may determine that the user is likely to enter a period of reduced network capabilities. For instance, the card system 300 may implement a set of rules that determine when a user device 200 is likely to enter a period of reduced network capabilities. A rule may define one or more conditions that lead to the inference that the user device 200 is likely to enter a period of reduced network capabilities. For example, if the card system 300 is affiliated with or serves an airline application, the airline application may have knowledge of a user's upcoming itinerary. Thus, if the user is set to depart on a flight at a particular time, and the user device 200 is located within a predetermined radius of the airline terminal from which the user is to depart within one hour of the departure time, the card system 300 may determine that it is likely that the user is about to enter a period of reduced network capabilities (e.g., the user is likely to put the user device 200 in “airplane mode”).

In implementations where the user device 200 transmits a request 120 to the card system 300 for an offline card, the user device 200 is tasked with determining that the user device 200 is likely to enter a period of reduced network capabilities. The user device 200 may utilize a set of one or more rules to determine whether a user device 200 is likely to enter a period of reduced network capabilities. Furthermore, in some implementations, the user device 200 may learn behavior patterns of a user to make such determinations. For instance, a user device 200 may learn that a user leaves a first location each weekday at around 8:30 AM and travels to a second location. The user device 200 may further learn that the user leaves the second location typically around 6:00 PM and returns to the first location. In the event the user device learns that during the route between the first and second locations, the user typically travels to a dead zone (e.g., travels on the subway) or does not wish to receive data over the cellular network of the user device 200 (e.g., does not wish to consume limited “data”), the user device 200 can learn that the user is likely to enter a period of reduced network capabilities at around 8:30 AM and again at around 6:00 PM. Thus, the user device 200 can transmit a request 120 to the card system 300 each weekday at or around 8:15 AM and again at or around 5:45 PM.

The user device 200 receives the offline card object(s) 100 and caches (e.g., stores) the offline card object(s). When the user device 200 is in an offline condition, the user device 200 can retrieve one or more offline card objects 100 from the cache and display one or more cards based on the card data 102 in the respective one or more offline card objects 100. If the user selects a card (e.g., presses on the card), the user device 200 sets the state of the user device 200 to the state indicated by the card and based on the content data 106 contained in the offline card object. For example, if the card links to a state of a native application, the user device 200 may retrieve the content data 104 from cache, launch the native application, and pass the content data 104 to the native application. In this way, the native application displays the content based on the content data 104. In another example, the card may link to a website, whereby the content data represents one or more pages of the website. In response to a user selection of the card, the user device 200 may launch a default web browser and pass the content data 104 (e.g., HTML code) to the web browser, which in turns displays a website based on the content data 104. In some implementations, the content data 104 corresponds to a graphical user interface that receives user input via one or more input elements. In these implementations, upon the user inputting user input, the user device 200 caches the user input as return data 130 using a return data template 106 from the offline content object. Upon reestablishing a network connection, the user device 200 retrieves the return data 130 from a cache and transmits the return data 130 to a third party server 180. In this way, the user device 200 allows a user to interact with an application despite being in an offline condition. In some examples, a user may perform a transaction with the third party server 180 while the user device 200 is in an offline condition.

The card system 300 may further deliver online card objects (not shown), which can be used to display online cards. Unlike offline cards, online cards link to online resources and/or states of applications that require a network connection to fetch the content data 104. Thus, an online card may include a URL or an application access mechanism, whereby a web browser or native application requests data from a third party server 180 in response to a card being selected.

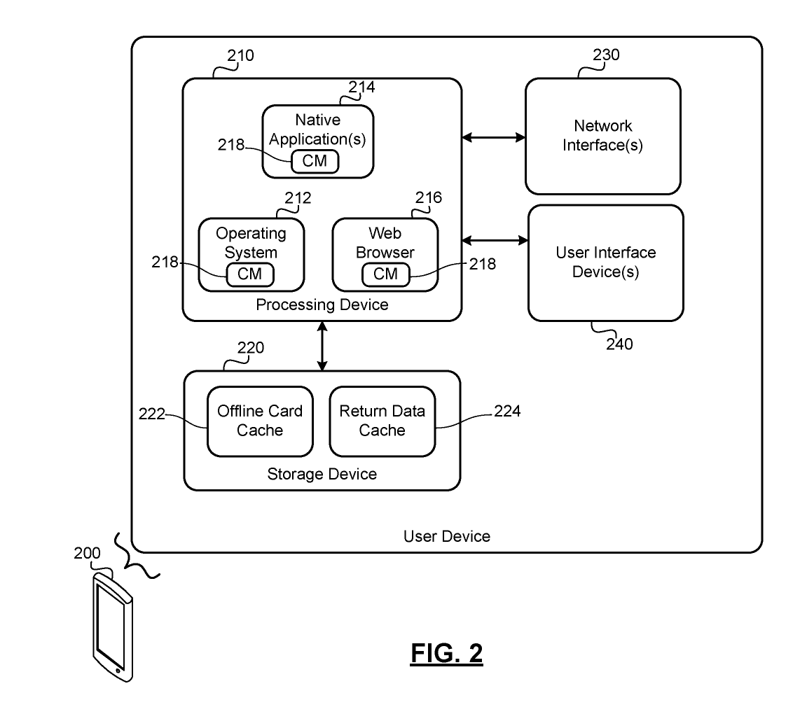

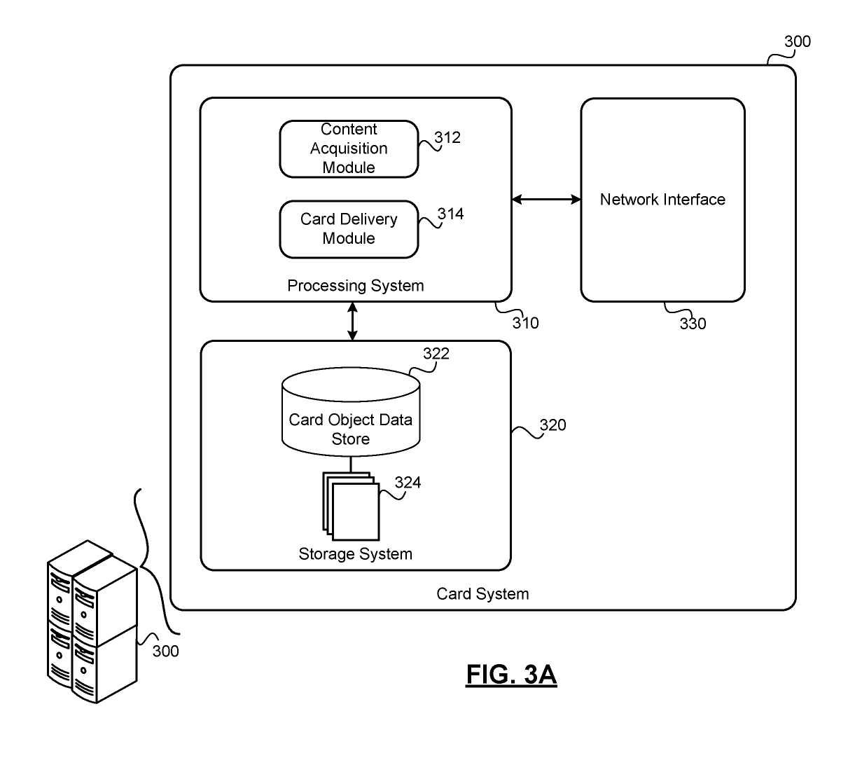

FIGS. 1B and 1C illustrate an example of a user device 200 in an offline condition. In the illustrated example of FIG. 1B, the user device 200 has launched an airline application. In this example, the user of the device is operating the application when the device is in an offline condition. For example, the user may be on a flight operated by an airline and may have the device 200 in “airplane mode.” Prior to the user boarding the airplane, the user device 200 (or a card system 300) may detect that the user device 200 is likely to begin a period of reduced network capabilities. Thus, the user device 200 may issue a request 120 to the card system 300 for one or more offline cards. As will be discussed, a card module (FIG. 2) may monitor one or more conditions of the user device 200 to make this determination and may subsequently issue the request 120 when it is likely that the user device will being a period of reduced network capabilities. In response to the request 120, the card system 300 transmits one or more card objects 100 to the user device 200. Alternatively, the card system 300 may make the determination that a user device 200 is likely to being a period of reduced network capabilities. In response to this determination, the card system 300 may push (e.g., transmit without a request 120) one or more offline card objects 100 to the user device 200.

In the illustrated example, the card system 300 has delivered at least three offline card objects 100. Assuming the airline application is aware of a traveler's itinerary, the example airline application determines that the user in this example is traveling from Detroit, Mich. to Denver, Colo. In this example, a first offline card 170-1 links to a state of a review application named “The Revue” that lists the best restaurants in Denver. A second offline card 170-2 links to a state of a sports news application named “Sports Report” that provides an article on the Detroit Tigers. A third offline card 170-3 links to a sponsored state of a retail application named “Deal Maker,” where a user can purchase a remote controlled drone. In this example, the first and second cards 170-1, 170-2 are presented because the linked to content may be of interest to the user, while the third card 170-3 is presented because an advertiser paid to have the card presented.

In FIG. 1C, the user has selected (e.g., pressed on) the third card 170-3. In response to selecting the third card 170-3, the user device 200 launches the Deal Maker application (either a native or web application edition). The user device 200 passes the content 104 to the Deal Maker application, which displays an offer to purchase a remote-controlled drone for $250.00. The user can purchase the remote-controlled drone by clicking on the purchase button 172.

In FIG. 1D, the user has opted to purchase the drone by clicking on the button 172 in FIG. 1C. In response to the user selection, the Deal Maker application displays a screen where the user can enter information to purchase the drone, including credit card information and shipping information. Once the user has entered the information, the user device 200 caches the information until the user device 200 reestablishes a network connection. Once this occurs, the user device transmits the information to a server associated with the Deal Maker application, thereby completing the transaction.

The example of FIGS. 1B-1D are provided for illustrative purposes. Offline cards may be presented in other situations and scenarios.

FIG. 2 illustrates an example user device 200 configured to display offline cards 170 when a user device 200 is in an offline condition. In the illustrated example, the user device 200 includes a processing device 210, a storage device 220, a network interface 230, and a user interface device 240. The user device 200 may include additional components not shown in FIG. 2. The components of the user device 200 may be interconnected by a bus or other communication circuitry.

The processing device 210 can include one or more processors that execute computer-executable instructions and associated memory (e.g., RAM and/or ROM) that stores the computer-executable instructions. In implementations where the processing device 210 includes more than one processor, the processors can execute in a distributed or individual manner. The processing device 210 can execute an operating system 212, one or more native applications 214, and a web browser 216, all of which can be implemented as computer-readable instructions. One or more of the operating system 212, the one or more native applications 214, and/or the web browser 216 may include a card module 218.

The storage device 220 can include one or more computer-readable mediums (e.g., hard disk drives, solid state memory drives, flash memory drives, etc.). The storage device 220 can store any suitable data that is utilized by the operating system 212 of the user device 200 and/or any of the applications 214, 216 that are executed by the user device 200. In some implementations, the storage device 220 also stores an offline card cache 222 and/or a return data cache 224. An offline card cache 222 stores offline card objects 100. An offline card object 100 may be stored in the offline card cache 222 when the card module 218 (discussed below) receives the offline card object 100. An offline card object 100 may be purged from the cache in response to the card being selected by the user, the user device 200 reestablishing a network connection, and/or at predetermined intervals (e.g., after 24 hours).

The card module 218 stores return data 130 in the return data cache 224. Upon reestablishing a network connection, the card module 218 can retrieve the return data 130 from the return data cache 224. Return data 130 may be purged from the cache after the return data 130 has been transmitted to the third party server 180. The storage device 220 can be in communication with the processing device 210, such that the processing device 210 can retrieve any needed data therefrom.

The network interface 230 includes one or more devices that are configured to communicate with the network 150. The network interface 230 can include one or more transceivers for performing wired or wireless communication. Examples of the network interface 230 can include, but are not limited to, a transceiver configured to perform communications using the IEEE 802.11 wireless standard, an Ethernet port, a wireless transmitter, and a universal serial bus (USB) port.

The user interface 240 includes one or more devices that receive input from and/or provide output to a user. The user interface 240 can include, but is not limited to, a touchscreen, a display, a QWERTY keyboard, a numeric keypad, a touchpad, a microphone, and/or speakers.

As previously discussed, the card module 218 may be implemented in the operating system 212 of the user device 200, one or more of the native applications 214 executing on the user device 200, and/or the web browser 216 of the user device 200. The card module 218 may be configured to determine when the user device 200 is likely to enter a period of reduced network capabilities. In these implementations, the card module 218 issues a request 120 to the card system 300 upon determining that the user device 200 is likely to enter a period of reduced network capabilities. The request 120 may be a request for one or more offline card objects 100, or may contain additional information. Additional information may indicate a destination of a user, a location of a user, a hometown of a user, interests of the user, or any other information that may aid the card system 300 in determining which information to show. In response to a request 120, the card module 218 receives one or more offline card objects 100 from the card system 300.

The card module 218 determines whether the user device 200 is likely to enter a period of reduced network capabilities in any suitable manner. In some implementations, the card module 218 utilizes a set of rules from which the card module 218 can infer that the user device 200 is likely to enter a period of reduced network capabilities. In some implementations, the rules may be specific to an application. For example, an airline application may have specific knowledge of when a user may be on an airplane, and thus, likely to be in airplane mode. In this example, a rule may state that a user device is likely to enter a period of reduced network capabilities if the itinerary associated with the user logged into the native application edition of the airline application installed on the user device indicates a scheduled flight in an upcoming period (e.g., in the next four hours). In a variation of this rule, the rule may state that a user device is likely to enter a period of reduced network capabilities if the itinerary associated with the user logged into the native application edition of the airline application installed on the user device indicates a scheduled flight in an upcoming period and the user device 200 is within a threshold distance (e.g., two miles) of the departure airport. In some implementations, the rules may be generic rules that can be applied across many applications. In these implementations, a rule may be based on a user's learned behavior patterns and/or based on known “dead-zones” in which there is reduced network availability. In one example, the card module 218 may be privy to a user's departure and return times between the user's home and the user's school or place of business (e.g., Monday-Friday, departs at 8:30 and returns at 6:30). Also, the card module 218 may be privy to the route that the user takes (e.g., takes the A-train, which does not have network connection). Thus, an example rule may state if the user behavior patterns associated with the next X minutes (e.g., next 60 minutes) usually take the user device 200 into a dead zone, then the device is likely to enter a period of reduced network capabilities. In this example, the card module 218 is privy to the user behavior patterns and thus would determine that the user device 200 is likely to enter a period of reduced network capabilities before departing and returning from work or school. The foregoing are examples of rules and not intended to limit the disclosure. The card module 218 may implement other suitable rules. Once the card module 218 determines that a user device 200 is likely to enter a period of reduced network capabilities, the card module 218 transmits a request 120 to the card system 300.

In some implementations, the card module 218 passively receives offline card objects 100 from the card system 300. In these implementations, the card system 300 is tasked with determining when the user device 200 is likely to enter a period of reduced network capabilities. When the card system 300 determines that the user device 200 is likely to enter a period of reduced network capabilities, the card system 300 may push one or more offline card objects 100 to the user device. Additionally or alternatively, the card system 300 may push one or more offline card objects 100 to the user device 200, regardless of whether the device 200 is likely to enter a period of reduced network capabilities. For example, the card system 300 may push a set of offline card objects 100 each hour of the day. If the user device 200 does not enter a period of reduced network capabilities, the card module 218 can purge the offline card objects 100 from the offline card cache 222.

The card module 218 receives offline card objects 100 and stores the offline card objects 100 in the offline card cache 222. In some implementations, the card module 218 may associate the offline card object with an access mechanism such as a URL or an access mechanism that corresponds to the state indicated by the offline card object. This association may be used to retrieve the offline card object 100, should an offline card 170 be selected by the user. For example, an offline card object 100 may correspond to a state of a web application that can ordinarily be accessed at: www.example 123.com/state1. When the card module 218 stores the offline card object 100 in the offline card cache 222, the card module 218 may associate the offline card object with the URL, www.example 123.com/state1 in a table that indexes the offline card objects 100 in the offline card cache 222. In this way, if the offline card 170 is presented and subsequently selected, the card module 218 can retrieve the content 104 of the selected card 170, while a web browser 216 treats the selection of the offline card 170 as if it were an online card. Namely, the web browser 216 may still display the URL to the user, despite the content displayed by the web browser being fetched from the offline card object 130 and not from a remote resource using the URL.

Upon determining that the user device 200 is in an offline condition, thereby beginning a period of reduced network capabilities, the card module 218 displays one or more offline cards 170 based on one or more respective offline card objects 100. The card module 218 can determine which cards 170 to display in any suitable manner. For example, the card module 218 may display the cards 170 in a first-in-first-out manner, based on an order provided by the card system 300, or based on respective relevance scores associated with the offline card objects 100. Once determining which offline card(s) to display, the card module 218 retrieves the offline card object 100 and presents the offline card 170 based on the card data 102 contained therein. The card module 218 can present the offline card 170 in the graphical user interface of the active application. The active application is the application currently being presented to the user.

A user may select an offline card 170 by, for example, pressing or clicking on the card 170. Upon pressing or clicking on the card 170, the card module 218 may retrieve the offline card object 100 from the offline card cache 222, and in particular, the content data 104 of the offline card object 100. The card module 218 can launch a web browser 216 or a native application 214 (if the offline card 170 represents a state of a native application), assuming the web browser 216 or the native application is not already launched. In the event the offline card 170 corresponds to a web application edition, the card module 218 can pass the content data 104 to the web browser 214 as if it were transmitted from the third party server via HTTP (Hyper Text Transfer Protocol). In the event the offline card 170 corresponds to a native application, the card module 218 can pass the content data 104 to the native application as if the native application was communicating with the server of the application.

In some scenarios, the content that is presented can receive user input. For example, the content may allow a user to purchase a product. If the user provides user input, the card module 212 can obtain the user input from the web browser or the native application. The card module 212 can format this data into return data 130 using the return data template 106 contained in the offline card object 100. The card module 212 can then store the return data 130 in the return data cache 224. Once the user device 200 reestablishes a network connection, the card module 212 empties the return data 130 stored in the return data cache 224 and transmits the return data 130 to a third party server.

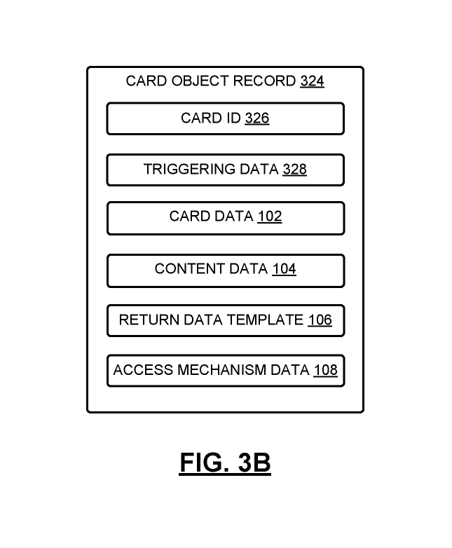

FIG. 3A illustrates an example of a card system 300. The card system 300 is configured to acquire content, generate offline card records based on the acquired content, and serve offline card objects 100 to user devices 200. The card system 300 may include a processing system 310, a storage system 320, and a network interface 330.

The processing system 310 is a collection of one or more processors that execute computer readable instructions. In implementations having two or more processors, the two or more processors can operate in an individual or distributed manner. In these implementations, the processors may be connected via a bus and/or a network. The processors may be located in the same physical device or may be located in different physical devices. Moreover, the processors may be located at different physical locations. The processing system 310 executes a content acquisition module 312 and a card delivery module 314. The content acquisition module 312 obtains content from third party servers and generates card object records 324 (e.g., FIG. 3B) based on the obtained content. The card delivery module 314 determines which card objects to provide to a user device 200. The card delivery module 314 may do so in response to a request 120 or in response to determining that the user device 200 is likely to enter a period of reduced network capabilities.

The network interface device 330 includes one or more devices that perform wired or wireless (e.g., Wi-Fi or cellular) communication. Examples of the devices may include, but are not limited to, a transceiver configured to perform communications using the IEEE 802.11 wireless standard, an Ethernet port, a wireless transmitter, and a universal serial bus (USB) port.

The storage system 320 includes one or more memory devices. The memory devices may be any suitable type of computer readable mediums, including but not limited to read-only memory, solid state memory devices, hard disk memory devices, and optical disk drives. The storage devices may be connected via a bus and/or a network. Storage devices may be located at the same physical location (e.g., in the same device and/or the same data center) or may be distributed across multiple physical locations (e.g., across multiple data centers).

The storage system 320 stores a card object data store 322. The card object data store 322 includes a plurality of card object records 324. The card object data store 322 may include one or more indexes (e.g., inverted indexes) that index the card object records 324.

FIG. 3B illustrates an example of a card object record 324 according to some implementations of the present disclosure. A card object record 324 corresponds to a state of an application. For example, card object records 324 may correspond to a news article, a review page of a restaurant, a page where a particular item may be purchased, or the like. In some implementations, a card object record 324 includes a card ID 326, triggering data 328, card data 102, content data 104, a return data template 106, and access mechanism data 108. The card ID 326 can be any string or value that uniquely identifies the record 324 from other records 324.

Triggering data 328 includes any data that causes the card delivery module 314 to select the record 324. Non-limiting examples of triggering data 328 may include categories, keywords, application IDs, or locations (e.g., airport code, city, state, or country). Each record 324 may be indexed by its triggering data 328. In this way, when a request 120 is received and indicates contextual information regarding the user device, the card delivery module 314 can determine which card object records 324 to retrieve. For example, a request 120 from a user device 200 may indicate a likely destination of a user (e.g., an airport code). In this example, the record 324 may correspond to an article listing the ten best restaurants in a particular city. In this example, the triggering data of a card object record 324 may include the name of the city or an airport code of the city.

Card data 102 includes any data and/or instructions used to render an offline card 170 at a user device 200. Card data 102 may include text, images, video, logos, and/or audio that are presented in an offline card 170. The card data 102 may be indicative of a linked to state of an application.

Content data 104 includes content that is displayed when the user selects an offline card 170. In some scenarios, the content data 104 corresponds to a web application (e.g., a website or a streamed application). In these scenarios, the content data 104 may be the data and/or instructions used to generate the linked to web page. For example, the content data 104 may be HTML, extensible markup language (XML), or JavaScript code that a web browser uses to display the content. In some scenarios, the content data 104 corresponds to a native application. In these scenarios, the content data 104 may be the data that is displayed by the native application.

Return data template 106 is a template that defines the data types that are received by the state of the application linked to by the offline card 170. In some implementations, a return data template 106 includes fields that receive values input by a user via a graphical user interface of the linked to application. Each field may be associated with (e.g., mapped to) a corresponding input element in the graphical user interface. When a user enters values into the graphical user interface, the values are mapped from the input elements to the respective fields. The return data template 106 also indicates an electronic resource to which the returned data 130 is transmitted.

Access mechanism data 108 indicates an access mechanism of a linked to state. For example, if the offline card 170 links to a state of a web application, the access mechanism data 108 may indicate a URL of the state. Similarly, if the offline card 170 links to a native application, the access mechanism data 108 may indicate an application resource identifier.

The example card object record 324 is provided for illustrative purposes. Additional or alternate data may be stored in the card object data records 324.

Referring back to FIG. 3A, the content acquisition module 312 collects data from third party applications (e.g., third party servers 180) and generates card object records 324 based thereon. In some implementations, the content acquisition module 312 includes and/or controls one or more crawlers that crawl different applications. In these implementations, the content acquisition module 312 actively requests documents that contain content from various applications. Additionally or alternatively, the content acquisition module 312 may provide a developer portal that allows application developers to upload their content to the content acquisition module 312. In these implementations, the content acquisition module 312 passively collects documents as they are uploaded by developers/content providers. In either scenario, the content acquisition module 312 receives a document (e.g., an HTML document, an XML document, or a JSON file) that includes the content defined at a state of an application and an access mechanism corresponding to the state.

The content acquisition module 312 can generate a card object record 324 based on the obtained content and access mechanism. The content acquisition module 312 may instantiate a new card object record 324 and may assign a new card ID 326 to the new card object record 324. The content acquisition module 312 can add the obtained document to the new card object record 324 as content data 104 and the access mechanism as the access mechanism data 108. The content acquisition module 312 can scrape any displayed text from the document and/or may identify any media such as images and videos from the document. The content acquisition module 312 can add the text and media to the content data 108 of the card object data record 324.

The content acquisition module 312 generates card data 102 that is used to render an offline card 170. In some implementations, the content acquisition module 312 automatically generates the card data 102. In these implementations, the content acquisition module 312 can scrape a document to obtain text and/or images that will appear in a rendered offline card 170. For example, the content acquisition module 312 can scrape a title of an article and a text snippet from the body of the article for inclusion in the card. The content acquisition module 312 can utilize a template to generate the card data 102. The template may include fields for the title, a text snippet, and a media item (e.g., an image or a video). Additionally or alternatively, the content acquisition module 312 may provide a portal that allows a developer/content provider to design a card. The developer/content provider may utilize the portal to insert the card content (e.g., text, images, logos, and/or video) that appear in the offline card. In these scenarios, the content acquisition module 312 may generate the card data 102 based on the card content provided by the user.

The content acquisition module 312 generates triggering data 328. The triggering data 328 can be any information that is used for selection. The triggering data 328 may include categories (e.g., sports, shopping, lifestyle, news, funny), locations (e.g., New York, Bay Area, Michigan), or location specific categories (e.g., Denver Area Attractions, New York Sports, San Francisco News). In some implementations, the content acquisition module 312 can determine the triggering data 328 of a card object record 324 based on the linked to content. For example, the triggering data 328 may be determined by classifying an article using a machine learner. Additionally or alternatively, the triggering data 328 may be provided by the developer/content provider. The content acquisition module 312 can index each card object record 324 according to the triggering data 328 of the card object record 324.

The card delivery module 314 provides offline card objects 100 to user devices 200. The card delivery module 314 selection can select a card object record 324, from which it bases an offline card object 100. In some implementations, the card delivery module 314 receives a request 120 from a user device for an offline card object 100. The request 100 may include context information, such as a destination location, a current location, an active application of the user device, an application that issued the request 120, and/or a user profile that lists interests of the user of the user device 200. Based on the context information, the card delivery module 314 may identify one or more card object records 324 from the card object data store 322. For instance, the context in the request 120 may be from an airline application and may indicate that the user is traveling to Denver, Colo. In this case, the card delivery module 314 may query the card object data store 322 using this context (e.g., querying an index with Destination=Denver). The card object data store 322 may output any records 324 that contain triggering data pertaining to Denver, Colo. In another example, the card delivery module 314 may know from a user profile that the user is into sports and, in particular, is a fan of the Washington Nationals Major League baseball team. In this example, the card delivery module 314 may query the card object data store 322 using this context (e.g., querying an index with topic=Washington Nationals). The card object data store 322 may output any records 324 that contain triggering data pertaining to the Washington Nationals.

The card delivery module 314 can generate offline card objects 100 to transmit to the user device based on the identified card object records 324. The card delivery module 314 can copy the card data 102, the content data 104, and the access mechanism data 106 from a card object record 324 into a newly instantiated offline card object 100. The card delivery module 314 can transmit the offline card object 100 to the user device 200 that provided the request 120. In some implementations, the card delivery module 314 can also score and rank the offline card objects. The score can be specific to a user (e.g., which content is the user most likely to find interesting) or can be generic (e.g., which content is the most popular). The card delivery module 314 may include a machine-learned scoring model that scores each offline card object 100 based on one or more features of the card object 100 and/or the context of the request 120.

In some implementations the content may be sponsored content, whereby the content provider agrees to pay a certain amount in exchange for displaying the sponsored content. In these implementations, the card delivery module 314 can score and rank the offline card objects based on an expected value associated with the offline card object. For instance, the score may be based on the product of the probability that a user will select an offline card and the amount of money to be paid if the card is selected.

In some implementations, the card delivery module 314 is further tasked with determining when a user device 200 is likely to enter a period of reduced network capabilities. In these implementations, the card delivery module 314 may utilize a set of rules to infer that a user device 200 is likely to enter a period of reduced network capabilities. For example, if the card system 300 is affiliated with or operated by an airline, the card system 300 may know when a user of a user device is likely to be boarding a flight. Thus the rule set may instruct the card delivery module 314 to push one or more card objects 100 to the user device 200 of the user one hour before a scheduled flight of the user. Furthermore, in this instance the card delivery module 314 can utilize the flight information (e.g., destination city, departure city) as context for selecting the card object records 324.

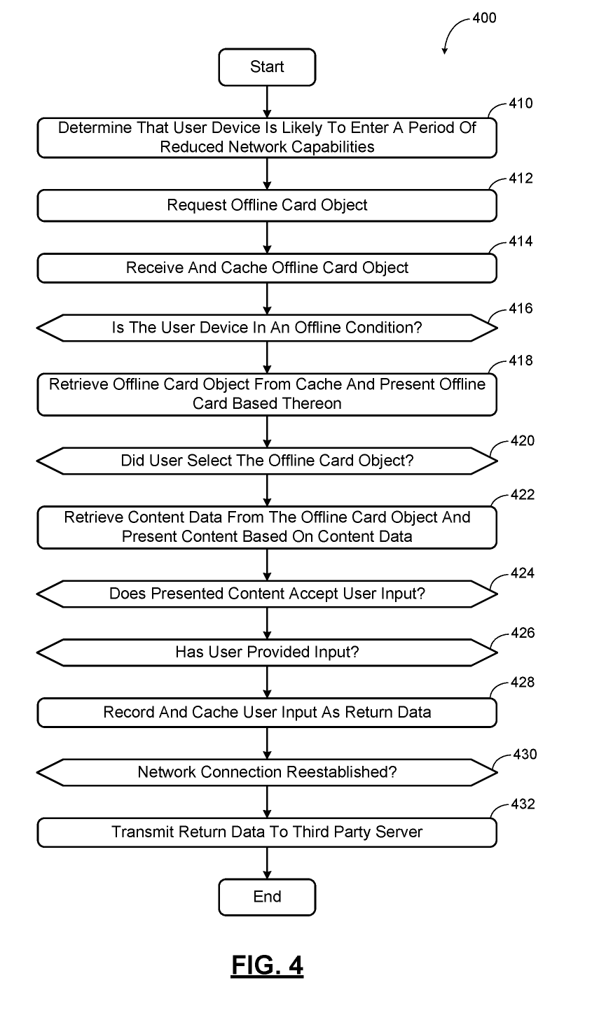

FIG. 4 illustrates an example set of operations of a method 400 for presenting offline content on a user device. The method may be performed by any suitable user device 200. For purposes of explanation, the method 400 is described with respect to the user device 200 of FIG. 2.

At 410, the card module 218 determines that the user device 200 is likely to enter a period of reduced network capabilities. As previously mentioned, the card module 218 may utilize a set of rules to determine when a user device is likely to enter a period of reduced network capabilities.

At 412, the card module 218 requests an offline card object 100 from a card system 300. In some implementations, the card module 218 generates a request 120. The request 120 may include one or more values indicating context. For example, the request may include a value indicating a location of the user device 200, a user profile of the user device 200, interests of a user of the user device 200, a destination of the user of the user device 200, or the like.

At 414, the card module 218 receives an offline card object 100 and caches the offline card object 100. The card module 218 may receive the offline card object 100 from the card system 300. The offline card object 100 may include card data 102 and content data 104. The offline card object 100 may further include a return data template 106 and/or access mechanism data 108. The card module 218 may store the offline card object 100 in an offline card cache 222.

At 416, the card module determines whether the user device 200 has entered an offline condition. The user device 200 may be in an offline condition when there is no connection to a network (e.g., out of service area or in airplane mode). Additionally, the user may set the user device 200 to not utilize a network connection unless the user is connected to a Wi-Fi connection. In such a scenario, the user device 200 may be considered in an offline condition if the user device 200 is only connected to the cellular network.

If the user device 200 is in an offline condition, the card module 218 retrieves the offline card object 100 from the cache 222, as shown at 418. The card module 218 can present an offline card 170 based on the card data 102 in the offline card object 100. The card module 218 may insert the offline card 170 into the graphical user interface of the active application.

At 420, the card module 218 determines whether the user has selected the offline card 170. The card module 218 may monitor a touch screen of the user device 200 to determine whether the user has selected (e.g., pressed on) the offline card. If the user selects the offline card 170, the card module 218 retrieves content data 104 from the offline card object 100 and presents the content based on the content data 104, as shown at 422. In some scenarios, the linked to content is a web page. In this scenario, the card module 218 may pass the content data 104 to the web browser of the user device 200. In other scenarios, the linked to content is native application content. In this scenario, the card module 218 may launch the native application (if necessary) and may pass the content data 104 to the native application.

In some implementations, the card module 218 allows a user to interact with the linked to application as if the user device 200 were online. Operations 424-432 correspond to these implementations.

At operation 424, the card module 218 determines whether the presented content accepts user input. If not, the card module 28 does not need to monitor the input of the user. If so, however, the card module 218 determines whether the user has provided input (e.g., the user entered any values via the user interface of the user device 200), as shown at 426. If so, the card module 218 records the user input and caches return data 130 based on the user input, as shown at 428. The card module 218 can store the received input in the return data template 106 contained in the offline card object 100. The card module 218 may store the return data 130 in the return data cache 224. At 430, the card module 218 determines whether the user device 200 has reestablished a network connection. If so, the card module 218 purges the return data 130 from the return data cache 224 and transmits the return data 130 to the respective third party server 180.

1. A method comprising:
selectively determining, by a processing device, that a user device including the processing device is likely to enter a period of reduced network capabilities by (i) determining a rule based on first information and (ii) evaluating the rule based on at least one of a present location of the user device and a present time;
in response to determining that the user device is likely to enter the period of reduced network capabilities:
selecting an offline card object from a plurality of offline card objects based on the first information; and
transmitting a message to a card system, wherein the message requests the card system to transmit the offline card object to a network interface device of the user device;
receiving, by the network interface device, the offline card object, wherein the offline card object includes card data and content data;
storing, by the processing device, the card data and the content data in an offline card cache of the user device;
detecting, by the processing device, that the user device is in an offline condition; and
while the user device remains in the offline condition:
selectively retrieving, by the processing device, the offline card object from the offline card cache;
displaying, by the processing device, a card based on the card data via a user interface of the user device, wherein the card comprises a user selectable link to view content corresponding to the content data;
receiving, by the processing device, a selection of the card via the user interface of the user device;
retrieving, by the processing device, the content data from the offline card cache; and
displaying, by the processing device, the content corresponding to the content data via the user interface.

2. The method of claim 1, wherein the content comprises a graphical user interface and includes i) one or more input elements that receive user input via the user interface and ii) an electronic address to which the user input is transmitted.

3. The method of claim 2, further comprising:
receiving, by the processing device via the user interface, the user input via the one or more input elements of the graphical user interface;
storing, by the processing device, return data in a return data cache; and
in response to the user device reentering an online condition, transmitting the return data to a server associated with the content.

4. The method of claim 3, wherein transmitting the return data comprises:
determining, by the processing device, that the user device has returned to the online condition, whereby the user device is able to communicate via the network interface device;
retrieving, by the processing device, the return data from the return data cache; and
transmitting, by the processing device, the return data to the server associated with the content via the network interface device.

5. The method of claim 4, wherein returning to the online condition includes one of: reestablishing any type of network connection, reestablishing a secure network connection, or reestablishing a Wi-Fi connection.

6. The method of claim 1, wherein the card is configured to direct the user device to a native application.

7. The method of claim 6, wherein displaying the content includes:
launching, by the processing device, the native application; and
passing, by the processing device, the content to the native application.

8. The method of claim 1, wherein the card is configured to direct the user device to a web application.

9. The method of claim 8, wherein displaying the content includes:
launching, by the processing device, a web browser installed on the user device; and
passing, by the processing device, the content to the web browser.

10. (canceled)

11. A non-transitory computer-readable medium storing a set of computer-executable instructions, the computer-executable instructions causing a processing device of a user device to:
selectively determine that the user device is likely to enter a period of reduced network capabilities by (i) determining a rule based on first information and (ii) evaluating the rule based on at least one of a present location of the user device and a present time;
in response to determining that the user device is likely to enter the period of reduced network capabilities:
select an offline card object from a plurality of offline card objects based on the first information; and
transmit a message to a card system, wherein the message requests the card system to transmit the offline card object to a network interface device of the user device;
receive the offline card object, wherein the offline card object includes card data and content data;
store the card data and the content data in an offline card cache;
detect that the user device is in an offline condition; and
while the user device remains in the offline condition:
selectively retrieve the offline card object from the offline card cache;
display a card based on the card data via a user interface of the user device, wherein the card comprises a user selectable link to view content corresponding to the content data;
receive a selection of the card via the user interface of the user device;
retrieve the content data from the offline card cache; and
display the content corresponding to the content data via the user interface.

12. The non-transitory computer-readable medium of claim 11, wherein the content comprises a graphical user interface and includes i) one or more input elements that receive user input via the user interface and ii) an electronic address to which the user input is transmitted.

13. The non-transitory computer-readable medium of claim 12, wherein the computer-executable instructions further cause the processing device to:
receive, via the user interface, the user input via the one or more input elements of the graphical user interface;
store return data in a return data cache; and
in response to the user device reentering an online condition, transmit the return data to a server associated with the content.

14. The non-transitory computer-readable medium of claim 13, wherein transmitting the return data comprises:
determining, by the processing device, that the user device has returned to the online condition, whereby the user device is able to communicate via the network interface device;
retrieving, by the processing device, the return data from the return data cache; and
transmitting, by the processing device, the return data to the server associated with the content via the network interface device.

15. The non-transitory computer-readable medium of claim 14, wherein returning to the online condition includes one of: reestablishing any type of network connection, reestablishing a secure network connection, or reestablishing a Wi-Fi connection.

16. The non-transitory computer-readable medium of claim 11, wherein the card is configured to direct the user device to a native application.

17. The non-transitory computer-readable medium of claim 16, wherein displaying the content includes:
launching the native application; and
passing the content to the native application.

18. The non-transitory computer-readable medium of claim 11, wherein the card is configured to direct the user device to a web application.

19. The non-transitory computer-readable medium of claim 18, wherein displaying the content includes:
launching a web browser installed on the user device; and
passing the content to the web browser.

20. (canceled)
